(19) United States
(12) Patent Application Publication
(10) Pub. No.: US 2006/0024226 A1
(43) Pub. Date: Feb. 2, 2006

(54) Catalyst and method for decomposition of perfluoro-compound in waste gas

(76) Inventors: Yong-Ki Park, Daejeon (KR); Jong Jeon Reol, Daejeon (KR); Hee Young Kim, Daejeon (KR); Dong Chae Lee, Seoul (KR)

Correspondence Address: Ronald R Santucci;Frommer Lawrence & Haug, 745 Fifth Avenue, New York, NY, 10151, US

(21) Appl. No.: 10/527,261

(22) PCT Filed: Jun. 2, 2003
(86) PCT No.: PCT/KR03/01081

§ 371 Date: Mar. 9, 2005

(30) Foreign Application Priority Data
Sep. 16, 2002 (KR) 10-2002-56218

(51) Int. Cl. B01J 27/187; B01J 27/14

(52) U.S. Cl. 423/240 S; 502/208

(57) ABSTRACT

The present invention relates to a catalyst for the decomposition of exhausted perfluoro-compounds (PFCs) and a catalytic decomposition method of PFCs by using the same. More particularly, the present invention relates to a PFC decomposition catalyst prepared in such a manner that a surface of aluminum oxide is loaded with phosphorous (P) component at a aluminum/phosphorous mole ratio of 10 to 100 and a decomposition method of PFCs by using the catalyst. The present catalyst can be decomposed PFCs at 100% rate exhausted from semiconductor manufacturing industry and thus prevent the release of PFCs having high global warming potential into atmosphere.

### TECHNICAL FIELD

The present invention relates to a catalyst for decomposing perfluoro-compounds (PFCs) in waste gas and a method for decomposing perfluoro-compounds by using the same. More particularly, the present invention relates to a catalyst for decomposing PFCs prepared in such a manner that a surface of aluminum oxide is loaded with phosphorous (P) component at a mole ratio of aluminum/phosphorous ranging from 10 to 100 and a method for decomposing PFCs by using the catalyst. The catalyst of the present invention can decompose 100% of PFCs exhausted in semiconductor and LCD manufacturing processes, which can prevent the release of PFCs that causes global warming into the atmosphere.

### BACKGROUND ART

PFCs are widely used as an etchant in semiconductor or LCD etching process and as a cleaning gas in chemical vapor deposition process. PFCs having usages as described above include CF₄, CHF₃, CH₂F₂, C₂F₄, C₂F₆, C₃F₆, C₃F₈, C₄F₈, C₄F₁₀, NF₃, SF₆ and the like. Besides in semiconductor and LCD proceses, PFCs can also be employed to replace chloro-fluorocarbons (CFCs) that have been used as a cleaning gas, an etchant, a solvent, and a raw material for reaction.

The PFCs are safer and more stable than CFCs but, due to their high global warming potential which is from several thousands to several tens thousand times higher than that of carbon dioxide, their exhaust into atmosphere is expected to be in more strict regulation.

For the abatement of PFCs exhausted from industries, several types of treatment methods such as a) direct burning, b) plasma decomposition, c) recovery and d) catalytic decomposition have been suggested but their commercial applications are limited due to due to their own drawbacks. The followings are brief discussion on each of the PFC-treating methods.

(a) The direct burning of PFCs, wherein wasted PFCs are decomposed directly by burning with a flammable gas, is considered to be a most convenient and plausible one. It requires an extremely high temperature of above 1,400° C., which accompanies several drawbacks such as system indurability and formation of toxic by-products. That is, due to the high temperature i) a lot of thermal Noₓ are formed by the reaction of nitrogen and oxygen contained in waste gas and ii) the burning apparatus are suffered severely from corrosion by the HF generated in decomposition of PFCs.

(b) A plasma decomposition method, wherein wasted PFCs are passed through a plasma region and then decomposed, is also one of effective decomposition methods. However, the radicals generated by plasma have high energy state and make the PFCs molecules decomposed randomly and unselectively, which resulted in a generation of by-products such as NOₓ, O₃, COF₂ and CO together with the desired products of CO₂ and F₂. In addition, the plasma generating system does not provide sufficient durability for continuous operation.

(c) A recovery method, wherein the exhausted PFCs are separated by using PSA (pressure swing adsorption) or membrane, has been considered to be more advantageous than the decomposition methods because the PFCs can be recycled. To ensure economic feasibility, the PFCs have to be recovered in high purity and at low cost but practically it is not easy to recover the PFCs in high purity discharged irregularly in small amount in scattered places.

(d) A catalytic method, wherein PFCs are decomposed by a catalyst in the temperature range of 500-800° C., can greatly reduce the formation of thermal Noₓ and corrosion problems of apparatus. Therefore, catalytic decompositions have been studied extensively to replace direct burning and plasma decomposition methods. However, the lifetime of a catalyst has not been guaranteed enough for continuous operation in reactive HF environment. That is, to be commercialized, the catalyst has to have high thermal stability at the reaction temperature of 500-800° C. and chemical resistance in the presence of HF and water vapor. Therefore, the catalytic decomposition of PFCs is still under investigation.

The technologies related with catalytic decomposition, which the present invention is directed to, can be summarized as follows:

In catalytic decomposition of PFCs, hydrogen fluoride (hereinafter referred to as HF) produced as a by-product causes severe problems for the stability of a catalyst due to its strong corrosiveness and reactivity. That is, most of the candidate catalysts have been suffered from deactivation even though they have high initial decomposition activity. When the oxide catalysts are exposed in HF environment and high temperature for a long time, they are transformed gradually into a metal fluoride which is inactive catalytically and has very low surface area. To protect the formation of fluoride, there has been an effort to return the deactivated fluoride catalyst to the initial state of oxide through a reaction with water vapor. S. Karmalar et al. (journal of Catalysis, vol. 151, pp. 394(1995)) reported that it was possible to return the deactivated metal fluoride back to the metal oxide through the reverse reaction with water vapor. In this patent, it was found that it is also an efficient way to introduce water vapor together during the catalytic decomposition of exhausted PFCs. Japanese Patent Publication 2001-293335 teaches that γ-alumina having peaks of 2θ value at regions of 33°±1°, 37°±1°, 40°±1°, 46+±1° and 67°±1° in X-ray diffraction pattern and their peak intensities of no more than 100 is an effective catalyst for PFC decomposition. Although the γ-alumina exhibited high initial activity, the catalyst deactivated and its activity was not maintained under a reaction condition where HF was generated by PFC decomposition. Therefore, the catalyst has a limit for commercial application where a long lifetime of catalyst is required.

Japanese Patent Publication 11-70322 discloses complex oxides catalysts composed of aluminum oxide and at least one transition metal such as Zn, Ni, Ti and Fe incorporated into the aluminum oxide, which has been known as a solid acid catalyst for PFC decomposition. In these catalysts, a relatively large amount of transition metals ranging from 20 to 30 mole % was incorporated into the aluminum oxide.

In U.S. Pat. Nos. 6,023,007 and 6,162,957, Nakajo et al. teaches that various types of metal phosphates can be used as catalysts for PFC decomposition and also that non-crystalline metal phosphate prepared by a sol-gel method is preferred in preparing the catalyst. In this method, a large amount of P having Al/P mole ratio of less than 10 was used to be suitable for the formation of aluminum phosphate. In addition, it was also revealed that the complex oxide catalysts containing transition metals such as Ce, Ni and Y were more effective for the decomposition of PFCs than the aluminum phosphate itself and, in particular, an aluminum phosphate containing Ce, where the Al/Ce atomic ratio is 9:1, was effective in decomposing CF₄. However, the lifetime of a catalyst, a most important factor to be considered in commercialization, is not guaranteed, together with complicated preparation procedure of the catalyst.

Consequently, it has been required to prepare a durable catalyst having a lifetime of more than 1 year by using a simple preparation method.

For the preparation of a durable catalyst to overcome the shortcomings of the above-identified catalyst, extensive studies have been carried out and, as a result, it was found that aluminum oxide catalyst loaded with a certain amount of phosphorous (P) was quite effective for the decomposition of PFCs exhausted in semiconductor processes and had chemical and thermal stability enough for commercial application. Primarily, this invention is aimed to provide an efficient catalyst for the decomposition of PFCs exhausted in semiconductor manufacturing process, and can be further expanded for the decomposition of PFCs included in other waste gases.

### DISCLOSURE OF INVENTION

One aspect of the present invention is to provide an aluminum oxide catalyst, wherein the surface of said aluminum oxide is loaded with phosphorous (P) component at a mole ratio of aluminum/phosphorous ranging from 10 to 100 for decomposing perfluoro-compounds in waste gases and the other is to provide a method for decomposing perfluoro compounds catalytically, which comprises passing the waste gas containing the perfluoro-compounds through the catalyst in the presence of water vapor in the temperature range of 400-800° C.

The present invention will be described in more detail as follows. The present invention is directed for the decomposition of PFCs using a catalyst and water vapor, in which the improved catalytic activity capable of decomposing PFCs completely at a temperature of below 800° C. as well as improved catalyst durability was acquired.

The catalyst of this invention having the properties described above can be prepared by impregnating a precursor material containing phosphorous on the aluminum oxide, where aluminum/phosphorous (Al/P) mole ratio is in the range of 10-100, and followed by drying and calcining in the temperature range of 600 to 900° C.

Therein, the aluminum oxide means an alumina comprised of aluminum, oxygen and sometimes hydrates such as Al(OH)₃, AlO(OH), and Al₂O₃.xH₂O, which has been widely used as a catalyst or a catalyst support. The aluminum oxide shows several types of phase transitions at wide range of temperatures. In the case of tri-hydrated form of aluminum oxide, Al(OH)₃, there exist two types of crystalline phases of Gibbsite and Bayerite. If one water molecule is released from the above tri-hydrated aluminum oxide, monohydrated AlO(OH), i.e., Boehmite is formed. A further dehydration of Boehmite results in a transient phases of alumina represented by Al₂O₃.xH₂O (0<x<1). Depending on the crystal defects, several types of aluminas classified as γ-, δ- and ε-aluminas are generated. Among them, the γ-alumina having high porosity and surface area has been used most frequently as a catalytic support or a catalyst itself. If these aluminas undergoes further dehydration, a more dense and stable phase of α-Al₂O₃ (corundum) is formed ultimately.

Any types of aluminas described above can be used as a source of aluminum oxide for the preparation of PFC decomposition catalysts of the present invention. Related with the composition of a catalyst, even natural aluminas containing a lot of impurities as well as the synthetic aluminas containing relatively less amount of impurities can be used if a constraint of surface area higher than 20 m²/g is satisfied. However, considering an economical aspect and simplicity of catalyst preparation, the commercially-available aluminas such as γ-alumina(Y-Al₂O₃), aluminum trihydroxide, boehmite and pseudo-boehmite are used preferably as an alumina source.

The aluminum oxides can also be prepared by using aluminum precursors such as aluminum chloride (AlCl₃), aluminum nitrate (Al(NO₃)₃), aluminum hydroxide (Al(OH)₃) and aluminum sulfate (Al₂(SO₄)₃). If a water-soluble aluminum precursor is used, it is difficult to prepare alumina oxide catalyst loaded with surface-enriched P component because the inner part of aluminum oxide particles as well as their outer surface may be loaded with P component during the precipitation of precursors, which resulted in a high loading of P component. Therefore, a water-insoluble aluminum oxide precursor like aluminum hydroxide is preferred to a water-soluble precursor such as aluminum chloride, aluminum nitrate and aluminum sulfate for effective impregnation of P component because only the surface of aluminum oxide can be loaded with P component using aqueous solution of P-containing precursor. In the case of synthesizing boehmite and pseudo-boehmite, the hydrolysis of aluminum isopropoxide with water in the presence of isopropanol may be suggested. However, direct decomposition of aluminum isopropoxide is more preferred because it is possible to obtain boehmite and pseudo-boehmite with stronger acidity thereby obtaining a catalyst with higher decomposition activity of PFCs.

In order to prevent the transformation of acidic surface of the present aluminum oxide catalyst to a dense and inert one by the exposure to the hot water vapor and HF, a variety of phosphorous (P) components can be used as a phase stabilizer or a thermal stabilizer. However, it is preferred to use phosphate compounds, which do not contain metal components, such as diammonium hydrophosphate ((NH₃)₂HPO₄), ammoniumdihydrophosphate (NH₃H₂PO₄) or phosphoric acid (H₃PO₄) for the catalytic activity and thermal durability.

In particular, in order to make the aluminum oxide catalyst of this invention have high decomposition activity of PFCs and thermal durability, it is critical to adjust a content of P component loaded on the surface of aluminum oxide. If the surface of aluminum oxide is loaded with P component with aluminum/phosphorous (Al/P) mole ratio of less than 10, the acidity loss of aluminum oxide could be minimized due to the low loading of P but the content of P component was not enough to stabilize aluminum oxide phase and to prevent accumulation of fluoride (F) in the catalyst, which led to a deactivation of the catalyst. If the mole ratio of Al/P exceeded 100, there was a big improvement in the stability of a catalyst due to the high loading of P but the number of acid sites, where the hydrolysis of PFCs occurs, decreased too much to obtain a desired conversion rate of PFCs. Therefore, for the higher decomposition activity and durability of the catalyst of the present invention, it is necessary that the mole ratio of aluminum to phosphorous (Al/P) of the catalyst should be in the range of about 10 to 100. It is more preferred that Al/P be in the range of about 25 to 100.

The aluminum oxide catalyst of the present invention is significantly effective in decomposing PFCs contained in waste gas and maintains its high activity even when used for a long period of time, where the reasons for such high performances and properties are shown as follows.

Various oxidative and hydrolytic reactions will be involved in the process of decomposition of PFCs exhausted with water vapor and oxygen. A few reaction schemes involved in the process of decomposition of representative PFCs such as CF₄ and C₄F₈ could be suggested as follows.
CF₄+O₂→CO₂+2F₂ ΔG=+494.1 KJ/mol Scheme I
CF₄+2H₂O→CO₂+4HF ΔG=−150.3 KJ/mol Scheme II
C₄F₈+4H₂O+2O₂→4CO₂+8HF Scheme III
*Cat.+HF→Cat.-F Scheme IV
*Cat.-F.+H₂O →Cat.+HF Scheme V
(*Cat. refers to a PFC decomposition catalyst)

As indicated in Scheme I, the oxidation of PFCs by oxygen is not favorable due to extremely high positive Gibbs free energy. On the contrary, the decomposition PFCs by water is quite favorable thermodynamically due to its negative Gibbs free energy as indicated in Scheme II. When the PFCs are decomposed by water vapor, HF and CO₂ are produced as a product. Here, if the hydrogen/carbon ratio of PFCs is less than 4, the PFCs cannot be decomposed completely into CO₂ only by H₂O and additional oxygen is required as shown in Scheme III. However, even though the oxygen is required for the complete decomposition of C₄F₈, the decomposition reaction is mainly proceeded via hydrolysis by water vapor, as is the case with CF₄ decomposition rather than oxidation via oxygen.

The Scheme IV represents the formation of fluoride compounds through the reaction of PFC decomposition catalysts with the HF produced during PFCs decomposition. The Scheme V reveals that the fluoride compound formed by the Scheme IV can be returned to its original state of catalyst through the reverse reaction with water.

In particular, a trace amount of P component loaded on the surface of the catalyst of the present invention plays an important role for promoting the hydrolysis reaction of Scheme V as well as for a phase stabilizer of a catalyst. The role of P can be seen clearly from the result that the bare aluminum oxide without modification of P revealed the decomposition activity of PFCs only for 2 days due to the formation of aluminum fluoride (AlF₃) through the reaction of aluminum oxide with HF. Unlike bare aluminum oxide, however, if the P component is loaded on the surface of aluminum oxide, the Cat.-F formed on the surface of the catalyst reacts with the —OH groups generated by the introduced P component and returned to the original state of Cat. with the production of HF, which results in no accumulation of HF on the catalyst. That is, in the presence of P component, Scheme V becomes more favorable than Scheme IV above a specific temperature and F component does not accumulate on the catalyst surface. The effect of P could be seen clearly in hydrolysis of NF₃; in the case of pure aluminum oxide catalyst, as the reaction proceeded at the reaction temperature of 400-500° C., the F began to accumulate on the catalyst surface and the decomposition rate decreased gradually while only small amount of F component formed on the catalyst surface and the decomposition activity was maintained over the aluminum oxide catalyst modified with P of the present invention due to the more enhanced activity of Scheme IV than that of Scheme V.

The catalyst of this invention loaded with P component, where Al/P mole ratio is in the range of 10-100, exhibits high catalytic activity and durability in the temperature range of 400-800° C. and can be applied successfully for the decomposition of PFCs exhausted in semiconductor processes. That is, the catalyst of present invention could decompose the exhausted PFCs effectively and selectively for a long time without deactivation.

The catalyst of this invention having the characteristics described above may have various types of shapes such as granule, sphere, pellet, ring, and etc. and can be charged into a catalyst bed for the decomposition of PFCs. The exhausted PFCs together with water vapor are passed through this catalyst bed at a temperature of 400-800° C. and then decompose into CO₂ and HF. The water vapor/PFC mole ratio in the feed should be in the rage of 1-100 and oxygen could be introduced in the range of 0-50% together with water vapor without decrease in decomposition activity. There exist optimum reaction temperatures; if the temperature is lower than 400° C., the PFCs could not be decomposed completely and if it is higher than 800° C., the catalyst is deactivated more rapidly and thermal NOₓ begins to be generated. In addition, there also exists optimum water vapor content in the reaction feed; if the water vapor/PFC does not fall into the range mentioned above, the desired decomposition activity could not be obtained and the catalyst is deactivated. During the decomposition process of PFCs, the fluorine component is converted preferentially into fluorides such as HF and the carbon (C), nitrogen (N) and sulfur (S) components are converted into oxides such as CO₂, NO₂ and SO₃.

The catalytic reactions could be run in a fixed bed reactor or a fluidized bed reactor. The contact pattern of a reactant and a catalyst in the fixed bed reactor does not influence decomposition efficiency. That is, regardless of flow direction of the reactant, the catalyst showed same decomposition activities. In the case of a fluidized bed reactor, the exhausted gas may be introduced from the bottom of the reactor, contacts with fluidizing catalyst and then exhausted to the top of reactor. In order to decompose PFC effectively in the temperature range of 400-800° C., the exhausted gas containing PFCs, water, and oxygen should be preheated up to the corresponding reaction temperatures prior to the introduction to the catalyst bed.

Usually, the exhausted gases in semiconductor process contain other gases such as oxygen, nitrogen, water as well as other process gases except PFCs. In this case, the catalytic decomposition process of PFCs could be combined with other processes for the treatment of other exhausted gases. As an example, a pre-scrubbing system could be installed prior to the PFC decomposition process for the removal of silane gases such as SiH₄, SiHCl₃, SiH₂Cl₂ and SiF₄ and halogen gases such as HCl, HF, HBr, F₂ and Br₂ could be included in the exhausted gas. After the pretreatment, the exhausts may contain mainly PFCs together with oxygen, nitrogen and water.

The PFCs that can be decomposed by the present catalyst may be classified into three types of fluorine-containing compounds such as carbon-containing PFCs, nitrogen-containing PFCs and sulfur-containing PFCs. In the carbon-containing PFCs, saturated or unsaturated aliphatic components such as CF₄, CHF₃, CH₂F₂, C₂F₄, C₂F₆, C₃F₆, C₃F₈, C₄F₈ and C₄F₁₀ as well as cyclic aliphatic and aromatic perfluorocarbon could be included. NF₃ is one of representative nitrogen-containing PFCs while SF₄ and SF₆ are included in representative sulfur-containing PFCs.

As described above, the catalyst of this invention enables to decompose completely the before-mentioned PFCs, which are converted 100% into CO₂. Although the catalyst of this invention is mainly targeted for the treatment of exhausted PFCS in semiconductor process, it could be expanded for the treatment of PFCs generated in the manufacturing process or other processes using PFCs as a cleaning gas, an etchant, a solvent and a raw material for reaction.

### BRIEF DESCRIPTION OF DRAWINGS

The above objects and other characteristics and advantages of the present invention will become more apparent by describing in detail a preferred embodiment thereof with reference to the attached drawings, in which:

FIG. 1 shows decomposition temperatures of various types of PFCs in the reaction conditions described in Examples I to III;

FIG. 2 shows decomposition temperatures of various types of PFCs in the reaction conditions described in Example IV;

FIG. 3 shows the decomposition activity of CF₄ over the alumina-phosphate catalyst depending on the loading of P as described in Example V;

FIG. 4 shows the conversion of CF₄ depending on the concentration of CF₄ as described in Examples I and VI;

FIG. 5 shows the conversion of CF₄ depending on the water vapor/CF₄ mole ratio as described in Example VII;

FIG. 6 shows the conversion of CF₄ depending on the concentration of O₂ in the reactant as described in Example VIII; and

FIG. 7 shows a long-run test of the catalyst comprising 97.5 mole % of aluminum oxide and 2.5 mole % of P in the reaction condition as described in Example XI.

### BEST MODE FOR CARRYING OUT THE INVENTION

This invention is further illustrated by the following examples. However, the scope of this invention is not limited to these examples.

### EXAMPLE I

For the preparation of aluminum oxide catalyst loaded with 2.5 mole % (Al/P=39) of P, 0.2.7 g of (NH₃)₂HPO₄ dissolved in 35 g of distilled water was impregnated on 40 g of aluminum oxide (Al₂O₃) powder and then followed by oven drying at 100° C. for 10 hrs and calcining in muffle furnace at 750° C. for 10 hrs.

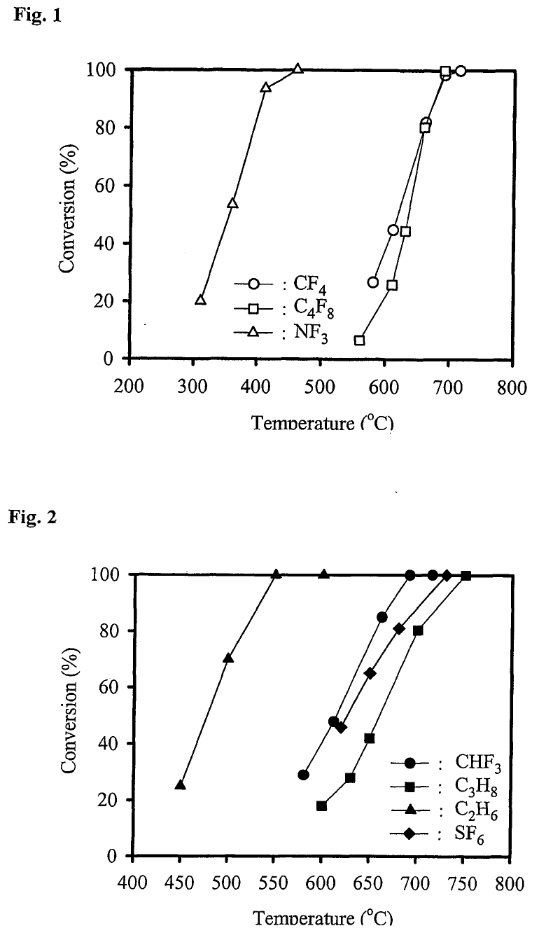

5 g of the obtained catalyst was charged into a ¾″ Inconel tube and then PFC decomposition reaction was carried out while flowing 1.01 ml/min CF₄, 2.87 mL/min O₂ and 89.4 ml/min He gases, which corresponds to 1.08 vol % of CF₄ anda space velocity of 1,500 h⁻¹ except water at room temperature. 0.04 ml/min of distilled water was introduced together with gas mixture using a syringe pump. The conversion of CF₄ was calculated based on the following formula 1. As shown in FIG. 1, the CF₄ was decomposed into to CO₂ with 100% selectivity above 690° C.
CF₄ Conversion=[1−(CF₄ concentration at outlet of reactor/CF₄ concentration at inlet of reactor)]×100 Formula 1
Selectivity to CO₂=(mole CO_{2,produced}/mole CF_{4,reacted})×100 Formula 2

### EXAMPLE II

NF₃ decomposition reaction was carried out in the same reaction condition as in Example I after loading 5 g of the catalyst prepared in Example I. Instead of CF₄, 1.01 ml/min NF₃, 2.87 ml/min O₂ and 89.4 ml/min He gases together with 0.04 ml/min distilled water were fed to the reactor. As shown in FIG. 1, 100% of NF₃ was decomposed above 400° C. Elemental analysis of the catalyst was carried out after 10 hours reaction at 500° C. using an energy dispersion x-ray analyzer (EDAX). It was found that F component did not accumulate in the catalyst even after reaction.

### EXAMPLE III

C₄F₈ decomposition reaction was carried out in the same reaction condition as in Example II after loading 5 g of the catalyst prepared in Example I. Instead of NF₃, 1.08 ml/min C₄F₈, 2.87 ml/min O₂ and 89.4 ml/min He gases together with 0.04 ml/min distilled water were fed to the reactor. As a result, it was found that 100% of C₄F₈ was decomposed into CO₂ above 690° C. (see FIG. 1).

### EXAMPLE IV

Using 5 g of the catalyst prepared in Example I, 1.0% of CHF₃, C₂F₆, C₃F₈ and SF₆ were decomposed, respectively. The flow rate of gases including PFCs and distilled water was adjusted to a space velocity of 1,500 h⁻¹ as in Example I. As shown in FIG. 2, all of CHF₃, C₂F₆, C₃F₈ and SF₆ were decomposed completely into CO₂ on the catalyst at below 750° C .

### EXAMPLE V

Four types of aluminum oxide catalysts with different loading of P were prepared. (NH₃)₂HPO₄ corresponding to 1 mole % (Al/P=99), 1.5 mole % (Al/P=65.7), 2 mole % (Al/P=49) and 2.5 mole % (Al/P=39) was dissolved in 35 g of distilled water was impregnated on 40 g of aluminum oxide (Al₂O₃) powder and then followed by oven drying at 100° C. for 10 hrs and calcining in muffle furnace at 750° C. for 10 hrs.

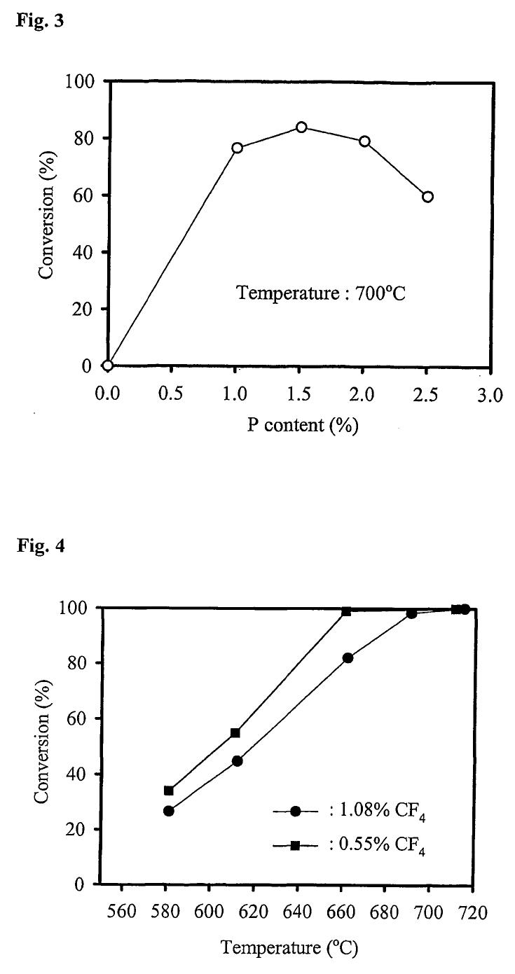

2 g of each obtained catalyst was charged into a fixed bed reactor and its decomposition activity of CF4 was examined in the flowing condition of 1.01 ml/min CF₄, 2.87 ml/min O₂, 89.4 ml/min He and 0.04 ml/min distilled water at 700° C. As shown in FIG. 3, the present catalysts comprising aluminum oxide and P revealed maximal activity at the loading of 1.5 mole % P(Al/P=65.7).

### EXAMPLE VI

Using 5 g of the catalyst prepared in Example I, 0.55 vol % of CF₄ was decomposed under the same conditions as Example I (space velocity=1,500 h⁻¹) and then compared with the result of Example I (decomposition of 1.08 vol % CF₄). It was found that the decomposition temperature was lowered as the concentration of CF₄ decreased. 0.55 vol % CF₄ could be decomposed completely even at 660° C. (see FIG. 4).

### EXAMPLE VII

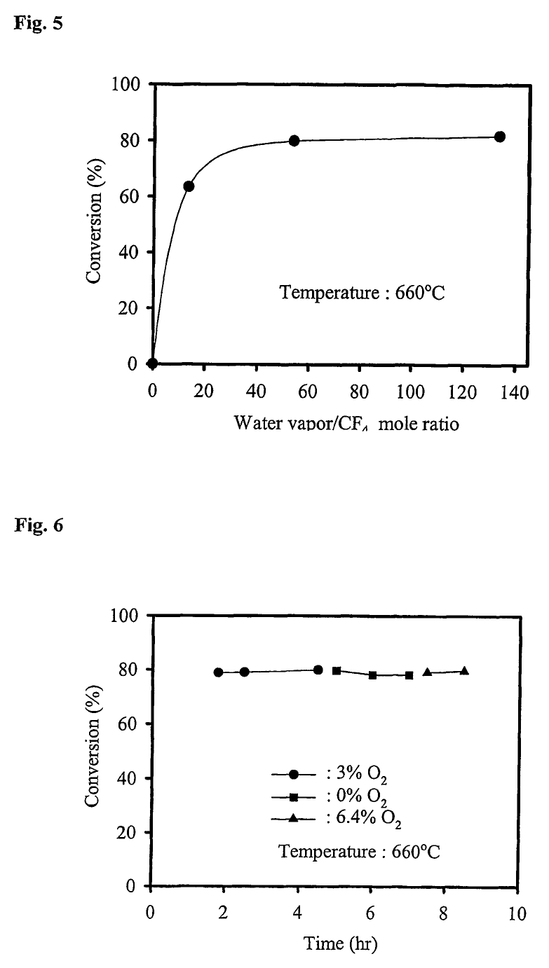

CF₄ decomposition was carried out while changing water/CF₄ mole ratio from 0 to 140. Using 5 g of the catalyst prepared in Example I, 1.08% CF₄ was decomposed at 660° C. and space velocity of 1,500 h⁻¹ as in Example I. It was found that there exists a critical water/CF₄ mole ratio to decompose CF₄ effectively. In this given reaction condition, at least water/CF₄ mole ratio of 30 was required to obtain maximum decomposition activity (FIG. 5).

### EXAMPLE VIII

CF₄ decomposition was carried out while changing O₂ concentration in the reactant from 0 to 6.5 vol %. Using 5 g of the catalyst prepared in Example I, 1.01% CF₄ was decomposed at 660° C., 0.04 ml/min distilled water and space velocity of 1,500 h⁻¹ as in Example I. Regardless of O₂ concentration, the catalyst showed same decomposition activities (see FIG. 6).

### EXAMPLE IX

Aluminum oxide catalyst loaded with P was prepared from four different aluminum oxide precursors. For the preparation of aluminum oxide catalysts loaded with 6 mole % P (Al/P=15.7), aqueous solutions of AlCl₃, Al(NO₃)₃, Al(OH)₃ and Al₂(SO₄)₃, respectively were co-precipitated with an aqueous solution of (NH₃)₂HPO₄.

Using 5 g of the prepared four different types of catalysts, decomposition reactions were carried out while flowing 1.08% CF₄, 2.87 ml/min O₂, 89.4 ml/min He and 0.04 ml/min distilled water at 700° C. and a space velocity of 1,500 h⁻¹. The four types of catalysts prepared by AlCl₃, Al(NO₃)₃, Al(OH)₃ and Al₂(SO₄)₃ precursors showed CF₄ conversion of 63, 68, 75 and 84%, respectively.

### EXAMPLE X

Aluminum oxide catalysts loaded with 2.5 mole % P (Al/P=39) were prepared by impregnation method using A(OH)₃, gamma-alumina and pseudo-boehmite particles as an aluminum oxide source and an aqueous solution of (NH₃)₂HPO₄ as a precursor of P, respectively.

Using 5 g of the prepared four different types of catalysts, decomposition reactions were carried out while flowing 1.08% CF₄, 2.87 ml/min O₂, 89.4 ml/min He and 0.04 ml/min distilled water at 700° C. and a space velocity of 1,500 h⁻¹. The three types of catalysts prepared from Al(OH)₃, gamma-alumina and pseudo-boehmite showed CF₄ conversion of 62, 44 and 90%, respectively.

### EXAMPLE XI

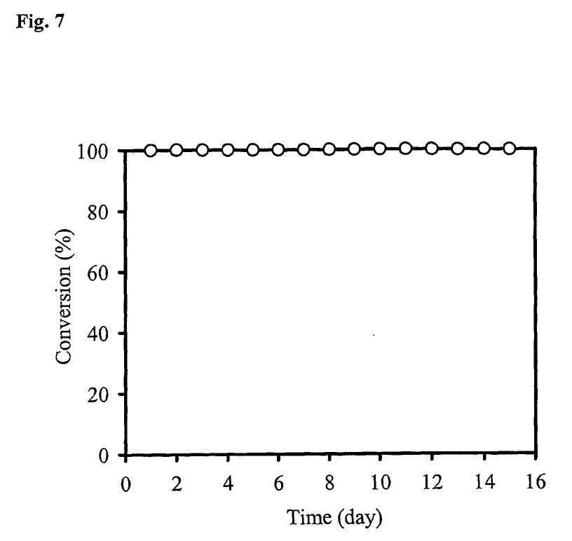

FIG. 7 represents the results of the catalyst prepared in Example I at 700° C. for a long operation time. After loading 5 g of the catalyst in a fixed bed reactor, decomposition reaction was carried out in the flowing condition of 1.01 ml/min CF₄, 2.87 ml/min O₂, 89.4 ml/min He and 0.04 ml/min distilled water. The initial catalytic activity was maintained constantly even after 15 days of operation without deactivation of catalyst and 100% CF₄ conversion was obtained.

### COMPARATIVE EXAMPLE I

For the comparison of catalytic activity, an aluminum phosphate catalyst was prepared according to the Example I in U.S. Pat. No. 6,162,957 and its catalytic activity was compared with that of present invention in the reaction conditions described in Example I. Compared with the P loaded aluminum oxide catalyst of present invention, the aluminum phosphate catalyst showed big difference in decomposition activity of CF₄; only 3% conversion of CF₄ was obtained over the aluminum phosphate catalyst while 100% conversion over the P loaded aluminum oxide catalyst.

### INDUSTRIAL APPLICABILITY

As described in Examples, the catalyst of this invention showed high decomposition activity and thermal stability at 400-800° C. even in the presence of water vapor, which can be applied to the decomposition of PFCs exhausted in semiconductor processes.

Furthermore, the catalyst in this invention has more advantages for commercialization since it can be prepared simply by the modification of commercially-available and environment-friendly aluminum oxide with a small amount of P at low cost without the incorporation of expensive or toxic metallic components.

1. An aluminum oxide catalyst for the hydrolytic decomposition of exhausted perfluoro-compounds by using water, wherein a surface of said aluminum oxide is loaded with phosphorous (P) component at an aluminum/phosphorous mole ratio of 10 to 100.

2. The aluminum oxide catalyst according to claim 1, wherein said aluminum oxide is selected from the group consisting of gamma alumina, aluminum trihydroxide, boehmite and pseudo-boehmite.

3. The aluminum oxide catalyst according to claim 1, wherein said phosphorous (P) component is selected from the group consisting of diammoniumhydrophosphate (NH₃)₂HPO₄), ammoniumdihydrophosphate (NH₃)H₂PO₄), and phosphoric acid (H₃PO₄).

4. The aluminum oxide according to claim 1, wherein said perfluoro-compounds include at least one selected from the group consisting of CF₄, CHF₃, CH₂F₂, C₂F₄, C₂F₆, C₃F₆, C₃F₈, C₄F₈, C₄F₁₀, NF₃ and SF₆.

5. A method of catalytic decomposition of exhausted perfluoro-compounds, which comprises passing said exhausted perfluoro-compounds through said catalyst of claim 1 in the presence of water vapor at the temperature range of 400-800° C.

6. The method according to claim 5, wherein said water vapor is contained at a water vapor/perfluoro-compound mole ratio of 1 to 100.

7. The method according to claim 5, wherein oxygen is added at a concentration of 0-50% together with said water vapor.
